(19) United States
(12) Patent Application Publication
(10) Pub. No.: US 2021/0163730 A1
(43) Pub. Date: Jun. 3, 2021

(54) METAL-POLYACETAL ASSEMBLY

(71) Applicant: DuPont Polymers, Inc., Wilmington, DE (US)

(72) Inventors: Marta Dal Molin, Meyrin (CH); Makoto Kato, Utsunomiya-shi (JP)

(21) Appl. No.: 17/263,298

(22) PCT Filed: Jul. 24, 2019
(86) PCT No.: PCT/US19/43170

§ 371 Date: Jan. 26, 2021

Related U.S. Application Data
(60) Provisional application No. 62/703,526, filed on Jul. 26, 2018.

(51) Int. Cl. C08L 59/04; B32B 15/098; B32B 15/18; B32B 27/42

(52) U.S. Cl. CPC C08L 59/04; B32B 27/42; B32B 15/18; B32B 15/098

(57) ABSTRACT

The invention provides an assembly comprising a polyacetal part and a metal part, wherein corrosion of the metal part is reduced by incorporating a carbodiimide in the polyacetal part.

### CROSS-REFERENCE TO RELATED APPLICATION

This application claims priority to U.S. Provisional Application. No. 62/703,526 filed on Jul. 26, 2018, which is incorporated herein by reference in its entirety.

### FIELD OF INVENTION

The present invention relates to the field of metal-polyacetal assemblies, particularly metal-polyacetal assemblies showing reduced metal corrosion.

### BACKGROUND OF THE INVENTION

Polyacetal, commonly referred to as “POM”, is often used in parts such as gears and bearings in machinery and conveyor belts. Such parts are commonly in contact with or close proximity to metal. It has been observed that under certain conditions, POM can induce corrosion of metal parts.

There is a need for POM formulations that decrease the corrosion of metal parts in proximity to the formulation.

### SUMMARY OF THE INVENTION

In a first aspect, the invention provides an assembly of at least two parts comprising:

(1) a plastic part comprising at least 20 wt % of polyacetal; and
(2) a metal part;
and wherein the polyacetal contains a carbodiimide.

### DETAILED DESCRIPTION OF THE INVENTION

The inventors have surprisingly found that when at least one carbodiimide is added to a polyacetal resin, metal parts in contact with or in proximity to a part made from such resin show reduced corrosion, as compared to metal parts in contact with or in proximity to polyacetal parts made from resin not having at least one carbodiimide.

The plastic part is made substantially from polyacetal resin. The polymer content may be exclusively polyacetal, or it may be a blend of one or more other polymers with polyacetal. Preferably it is made with a polymer content that is at least 20 wt % polyacetal, more preferably at least 30 wt % polyacetal, more particularly preferably at least 50 wt % polyacetal. In a particularly preferred embodiment, the polymer content is exclusively polyacetal.

The polyacetal resin used in this invention includes polymers or copolymers of formaldehyde, a formaldehyde cyclic oligomer, trioxane, or tetraoxane, or acetaldehyde, propionaldehyde, or the like, or polymers obtained by copolymerizing such as aldehyde with a cyclic ether or cyclic acetal, such as ethylene oxide, propylene oxide, 1,3-dioxalane, or the like. The polyacetal resin is a linear polymer comprising —(CH₂)ₙO main chain units (n is a natural number) and/or —(CHR—O)— units (R is an alkyl group), with terminal groups thereof being either not protected or being protected with a radical selected from the group consisting of —O—CO—CH₃, —OCH₃, and —O(CH₂)ₙ—OH. The polyacetal resin has a number average molecular weight of about 10,000 100,000, preferably 20,000-70,000. Polyacetal resin which is used in this invention may optionally be compounded, if needed, within the range of not adversely affecting the present invention, with heat stabilizers, antioxidants, plasticizers, tougheners, UV stabilizers, lubricants, fillers, colorants, pigments and the like.

Preferably the polyacetal used in the invention is a homopolymer or a copolymer. Homopolymer is made using formaldehyde alone as monomer. In copolymer, some of the —CH₂O— groups (for example about 1-1.5%) are replaced with —CH₂CH₂O— groups. Homopolymer is preferred.

The plastic part comprises one or more carbodiimides. A carbodiimide or a methanediimine is a functional group consisting of the formula RN═C═NR. The carbodiimides useful in the invention are not particularly limited, and the R radicals may be aliphatic (cyclic or linear) or aromatic, or a mixture. Aromatic radicals can carry substituents with at least 1 C atom, or one heteroatom such as N, S and/or 0.

While monomeric carbodiimides are useful in the invention, it is preferred to use polymeric carbodiimides. Polymeric carbodiimides are less toxic in handling and show less tendency to migrate in the polyacetal. Preferred polymeric carbodiimides have a molecular weight of greater than 700, more preferably greater than 1,500, particularly preferably greater than 2000. Aliphatic and aromatic polymeric carbodiimides may be used. Preferably the carbodiimide has a molecular weight under 350,000.

In preferred embodiments, the carbodiimide is a polymer of the following formula:

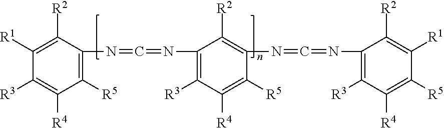

wherein R¹, R², R³, R⁴ and R⁵ are independently selected from H and alkyl radicals of 1-4 carbon atoms, and n is an integer from 8 to 12.

In a particularly preferred embodiment, the carbodiimide is a polymer having the following Formula A:

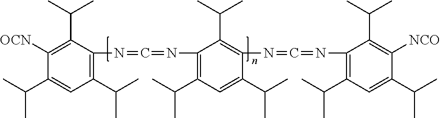

where n is an integer between 7-11, more preferably 8 and/or 9, based on number average molecular weight.

It is understood that polymers are distributions of molecules with different molecular weights, and that any number of repeat units or molecular weights specified herein are based on number average molecular weight.

Preferably, the polymeric carbodiimide shown immediately above has a molecular weight between 2,900 and 4,351, more preferably between 3,260 and 3626.

The carbodiimide is preferably present in a concentration of 0.01 to 0.3 wt %, more preferably it is present at a concentration greater 0.025 wt %, more preferably greater than 0.05 wt %, more particularly preferably greater than 0.075 wt %, based on the weight of the plastic part. Preferably the carbodiimide is present at not more than 2 wt %, based on the weight of the plastic part.

The metal part may be made of any metal that is prone to corrosion. This includes steels, in particular stainless steel and carbon steel. The invention is particularly suited to carbon steel, which typically shows a higher level of corrosion during use.

In a preferred embodiment of the assembly, the plastic part is made from at least 20 wt % polyacetal, more preferably at least 30 wt % polyacetal, more particularly preferably at least 50 wt % polyacetal, and most preferred 100 wt % polyacetal, wherein the polyacetal is homopolymer, the carbodiimide is a polymer of Formula A, having 8-9 monomer units, and is preferably present at 0.075-0.3 wt %. Preferably the polyacetal has a molecular weight of 70 kDa. Preferably the metal part is not more than 2 cm from the plastic part.

In a particularly preferred embodiment of the assembly, the plastic part is made from 100 wt % homopolymer having a molecular weight of 70 kDa, the carbodiimide is a polymer of Formula A, having 8-9 monomer units, based on number average molecular weight, and is preferably present at 0.2 wt %. Preferably the metal part is not more than 2 cm from the plastic part.

The assembly may be any mechanical, structural or decorative assembly in which a plastic part is in proximity to or in contact with a metal part. This includes, for example:
A polyacetal gear or wheel mounted on a metal shaft or rod;
A polyacetal gear or wheel in contact with or in proximity to a metal gear or wheel;
Metal parts inside a polyacetal housing;
Polyacetal parts inside a metal housing;

In preferred embodiments, the plastic part and the metal part interact, that is they touch over at least part of their surfaces, or they interact dynamically, for example in the case of a gear or wheel that is mounted on a metal shaft, or which is actuated by a metal wheel or gear. The reverse is also possible, that is a metal wheel or gear that is mounted on a plastic shaft or which is actuated by a plastic gear or wheel.

The expression “in proximity to” in a closed system means that the plastic part is not more than 10 cm, preferably not more than 5 cm, more particularly preferably not more than 2 cm or not more than 1 cm removed from the metal part. In an open system, the expression “in proximity to” means that the plastic part is not more than 5 cm, preferably not more than 1 cm removed from the metal part. In both closed and open systems, preferably the plastic part is not more than 5 mm, more preferably not more than 1 mm removed from the metal part, and particularly preferably in contact with the metal part.

### Fillers and/or Additives

The polyacetal resins described herein may include fillers, which include, but are not limited to reinforcing agents such as glass fibers and glass beads, carbon fibers and other reinforcing fibers, calcium carbonate, oxides such as alumina, silica, and titanium dioxide, sulfates such as barium sulfate, titanates, kaolin clay and other silicates, magnesium hydroxide, talc, wollastonite, other minerals, graphite, and carbon black.

The polyacetal resins described herein may also include additives such as lubricants, antioxidants, UV stabilizers, heat stabilizers, toughening agents, nucleating agents, mold release agents, plasticizers, antistatic agents, surfactants, and colorants. Suitable lubricant additives include silicone lubricants such as dimethylpolysiloxanes and their derivatives, oleic acid amides, and alkyl acid amides. Other suitable additives include formaldehyde scavengers, non-ionic surfactant lubricants, hydrocarbon waxes, chlorohydrocarbons, fluorocarbons, oxy-fatty acids, esters such as lower alcohol esters of fatty acids, polyvalent alcohols such as polyglycols and polyglycerols, and metal salts of fatty acids such as lauric acid and stearic acid. Suitable ultraviolet light stabilizers include benzotriazoles, benzophenones, aromatic benzoates, cyano acrylates, and oxalic acid anilides.

The polyacetal resins described herein may comprise any weight percent of fillers and additives disclosed herein or known in the art, either singularly or in any combination, ranging from 0 to 40 weight percent based on the weight of the plastic part. It is expressly contemplated herein that these plastic parts may comprise from 0 to 30 weight percent of fillers and up to 10 weight percent of additives.

### Examples

The base polymer was a homopolymer polyacetal acetate-capped with molecular weight around 70 KDa manufactured by DuPont. The carbodiimide was a polymer having the following structure:

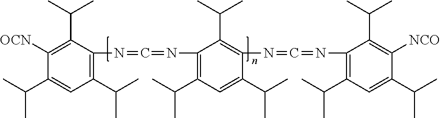

wherein n is 8 and/or 9 based on number average molecular weight.

All the ingredients used in the formulations were purchased from vendor and used without further purification. The ingredients were dry-blended and compounded on a twin screw extruder Berstorff ZE40A with barrels set at 190° C., screw speed 125 rpm, 35 kg/hr throughput. The extruded material was pelletized and dried at 80° C. for 3 hrs to remove excess moisture. Materials were injected into ISO tensile bars, setting barrels' temperature to obtain a melt temperature of 205° C. The mold temperature was set at 90° C.

Corrosion Experiments with Metal Rods

Carbon steel rods with 5 mm diameter and approximately 150 mm length were cleaned before starting the experiments to remove any anti-oxidant coating by full immersion in acetone in an ultrasonic bath for 15 min. After the treatment was completed, the rods were removed from the acetone bath, dried with a clean cloth and left in air overnight to remove all traces of acetone.

1 L glass jars equipped with air tight screw cap were used as corrosion chambers. In each jar 1 carbon steel rod, 3 POM tensile bars cut in half and a beaker containing approx. 50 mL of a saturated aqueous solution of KCl were added. The salt solution was added to maintain the relative humidity of the chamber at RH 78%. Care was taken to avoid any direct contact of the metal bars with the beaker containing the salt solution. A jar containing only the rod and the salt solution (no POM) was used as control. The POM was placed at approximately 2 cm from the steel rod.

The sealed jars were heated in an oven at 90° C. for 50 hrs. The jars were then cooled to room temperature, opened and the corrosion present on the metal rod was evaluated visually. After 50 hrs exposure, all the rods, including the control without any POM added, show some signs of corrosion. Corrosion is evidenced by the presence of a brown/black residue on the surface of the rods. When the above carbodiimide was used in the formulation of the polyacetal, the degree of corrosion of the rods was substantially decreased.

The amount of corrosion after 50 hrs of exposure was tentatively quantified with the help of a picture treatment software. After the experiment, a picture of each rod was taken with a Canon EOS 700D placed at fixed distance under the same illumination conditions. Lens opening and exposure time were regulated to have the best possible quality image and were kept constant for all the pictures.

The pictures were treated with an image processing software (ImageJ Fiji package). Each image was thresholded to create a binary image in which only the corroded areas were highlighted. The sum of the areas of the corroded parts was reported as percentage of the total area of each rod. The total % corroded area depends on the amount of carbodiimide added in the POM formulations (Table 1).

TABLE 1
Effect of carbodiimide content in polyacetal on corrosion of
adjacent metal part after 50 hours exposure at 90° C., 78% RH

| wt % carbodiimide | % surface corroded |
|---|---|
| 0 | 34 |
| 0.025 | 30 |
| 0.05 | 29 |
| 0.075 | 18 |
| 0.1 | 6 |
| 0.2 | 1 |

It is clear from Table 1 that the corroded surface decreases significantly when a carbodiimide is present.

1. An assembly of at least two parts comprising:
(1) a plastic part comprising at least 20 wt % of polyacetal; and
(2) a metal part;
and wherein the polyacetal contains a carbodiimide.

2. The assembly of claim 1, wherein the plastic part has a polymer content that is at least 50 wt % polyacetal.

3. The assembly of claim 2, wherein the polyacetal is homopolymer or copolymer of formaldehyde.

4. The assembly of claim 3, wherein the carbodiimide content in the polyacetal is between 0.01 to 1 wt %, based on the weight of the plastic part.

5. The assembly of claim 3, wherein the carbodiimide content in the polyacetal is between 0.01 to 0.3 wt %, based on the weight of the plastic part.

6. The assembly of claim 4, wherein the carbodiimide is present at a concentration greater than 0.025 wt %, based on the weight of the plastic part.

7. The assembly claim 4, wherein the carbodiimide is present at a concentration greater than 0.05 wt %, based on the weight of the plastic part.

8. The assembly of claim 6, wherein the carbodiimide is of the general formula RN═C═NR, wherein the R radicals are the same or different and are independently selected from aliphatic and aromatic radicals.

9. The assembly of claim 8, wherein the carbodiimide has aromatic R radicals.

10. The assembly claim 8, wherein the carbodiimide is polymeric.

11. The assembly of claim 10, wherein the carbodiimide is a polymer of the following formula: 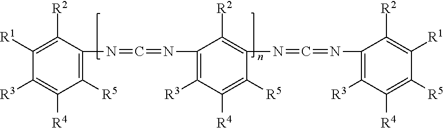
wherein R¹, R², R³, R⁴ and R⁵ are independently selected from H and alkyl radicals of 1-4 carbon atoms, and n is an integer from 8 to 12.

12. The assembly of claim 10, wherein the carbodiimide is a polymer of the formula: 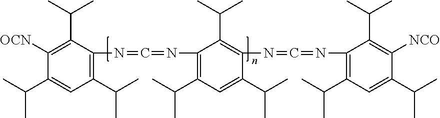
wherein n is 8 and/or 9, based on number average molecular weight.

13. The assembly of claim 10, wherein the carbodiimide has a molecular weight of greater than 700.

14. The assembly of claim 13, wherein the metal is selected from stainless steel and carbon steel.

15. The assembly of claim 14, wherein the plastic part is selected from the group consisting of a polyacetal gear or wheel; the metal part is a, gear, wheel, or rod, and wherein said polyacetal gear or wheel is in contact with or in proximity to said metal shaft, gear, rod, or wheel, wherein the plastic part is in contact with at least a portion of the metal part to not more than 5 mm removed from the metal part.
